(19) United States
(12) Patent Application Publication
(10) Pub. No.: US 2013/0129276 A1
(43) Pub. Date: May 23, 2013

(54) OPTICAL ENGINE ASSEMBLY AND OPTOELECTRONIC PACKAGE

(71) Applicants: Fang Jeng LIN, Taipei City (TW); Tsu Hsiu WU, Yilan County (TW); Shih Yu CHEN, Taichung City (TW); Chien Chuan YEH, Taipei City (TW); Kuang Hui HUANG, Taichung City (TW)

(72) Inventors: Fang Jeng LIN, Taipei City (TW); Tsu Hsiu WU, Yilan County (TW); Shih Yu CHEN, Taichung City (TW); Chien Chuan YEH, Taipei City (TW); Kuang Hui HUANG, Taichung City (TW)

(73) Assignee: UNIVERSAL MICROELECTRONICS CO., LTD., Taichung (TW)

(21) Appl. No.: 13/563,871

(22) Filed: Aug. 1, 2012

(30) Foreign Application Priority Data
Nov. 18, 2011 (TW) 100142236

(51) Int. Cl. G02B 6/12

(52) U.S. Cl. 385/14

(57) ABSTRACT

There is provided an optical engine assembly including a bench, at least one optoelectronic unit, at least one optical waveguide and a mount. At least one support groove and a positioning groove are formed on the bench and connected with each other, and the support groove perpendicularly extends outward from one side of the positioning groove. The optoelectronic unit is disposed at the other side of the positioning groove and aligned with the support groove. One end of the optical waveguide is placed inside the support groove and the other end thereof penetrates through at least one through hole of the mount.

### CROSS REFERENCE TO RELATED APPLICATION

This application claims the priority benefit of Taiwan Patent Application Serial Number 100142236, filed on Nov. 18, 2011, the full disclosure of which is incorporated herein by reference.

### BACKGROUND

1. Field of the Disclosure

This disclosure generally relates to an optoelectronic assembly and, more particularly, to an optical engine assembly and an optoelectronic package that do not use conventional light redirecting element to output and/or receive optical signals.

2. Description of the Related Art

Good alignment between an optical fiber and a laser light source or a photodetector can improve the coupling efficiency of light transmission. Due to the increase of the transmission capacity, how to improve the light coupling between a plurality of optical fibers and a plurality of laser light sources or photodetectors becomes an importance issue.

Please refer to FIG. 1, it shows a schematic diagram of a conventional optical engine assembly 9, which includes a substrate 91, a supporting member 92, a light redirecting element 93, an optoelectronic device 94 and a plurality of conductive lines 95. The optoelectronic device 94 is disposed on an upper surface of the substrate 91 and configured to generate or receive optical signals transmitting along a normal direction n of the substrate 91. The conductive lines 95 are formed on the upper surface of the substrate 91 and electrically coupled to the optoelectronic device 94 so as to input electric signals into the optoelectronic device 94 or to output electric signals from the optoelectronic device 94. The supporting member 92 is configured to support the light redirecting element 93 such that the light redirecting element 93 can be aligned with the optoelectronic device 94. The light redirecting element 93 redirects light transmitting in a direction along the normal direction n to a direction parallel to the upper surface of the substrate 91 and the redirected light is sent to an external optical connector.

Please refer to FIG. 2, it shows a bottom view of the light redirecting element 93 of FIG. 1, wherein a plurality of V-grooves 931 are formed in parallel at a bottom surface of the light redirecting element 93. A plurality of optical fibers 932 are respectively placed in the V-grooves 931 and an adhesive 933 is used to fix the optical fibers 932 inside the V-grooves 931. The optical fibers 932 are finally connected to an optical connector so as to transmit optical signals generated by the optoelectronic device 94 to outside of the optical engine assembly 9 or to receive external optical signals into the optoelectronic device 94.

Please refer to FIG. 3, it shows a cross-sectional view taken along line III-III′ of the optical engine assembly 9 of FIG. 1. In the conventional optical engine assembly 9, it is necessary to use the light redirecting element 93 to redirect vertical optical signals generated from the optoelectronic device 94 to horizontal optical signals or to redirect horizontal optical signals to vertical optical signals to be received by the optoelectronic device 94. The redirecting mechanism is to form a mirror surface 932S at the front end of the optical fibers 932, and the mirror surface 932 has a 45-degree beveled surface with respect to the normal direction n so as to reflect optical signals. In this structure, the front ends of the fibers 932 have to be polished and in some cases a metal layer is coated on the mirror surfaces 932S in order to increase the reflectivity thereof, but these procedures will increase the manufacturing complexity.

Accordingly, the present disclosure further provides an optical engine assembly and an optoelectronic device that may generate or receive optical signals parallel to the substrate without utilizing the conventional light redirecting element such that it is not necessary to form the 45-degree beveled mirror surface and not necessary to coat the metal layer at the front end of optical waveguides so as to reduce the manufacturing complexity.

### SUMMARY

It is an object of the present disclosure to provide an optical engine assembly and an optoelectronic package that are configured to perform optical coupling between at least one optoelectronic chip and at least one optical waveguide and do not use conventional light redirecting element to output or receive optical signals.

It is another object of the present disclosure to provide an optical engine assembly and an optoelectronic package that may simply the fabrication process and realize high coupling efficiency between the optoelectronic chip and the optical waveguide.

To achieve the above objects, the present disclosure provides an optical engine assembly including a bench, at least one optoelectronic unit, at least one optical waveguide and a mount. At least one support groove and a positioning groove are formed on an upper surface of the bench and connected with each other, and the support groove perpendicularly extends outward from one side of the support groove. The optoelectronic unit includes two electrodes, an optoelectronic chip, a horizontal surface and an active surface, wherein the two electrodes extend from the horizontal surface to the active surface, the optoelectronic chip is attached to the active surface and coupled to the two electrodes, the optoelectronic unit is disposed at the other side of the positioning groove and the optoelectronic chip is aligned with the support groove. One end of the optical waveguide is placed inside the support groove. The mount includes at least one through hole, wherein the other end of the optical waveguide penetrates through the at least one through hole.

The present disclosure further provides an optoelectronic package including a substrate, a control chip and an optical engine assembly. The control chip is attached to the substrate. The optical engine assembly is attached to the substrate and coupled to the control chip to output or receive optical signals, and further includes a bench, at least one optoelectronic unit, at least one optical waveguide and a mount. At least one support groove and a positioning groove are formed on an upper surface of the bench and connected with each other, and the support groove perpendicularly extends outward from one side of the support groove. The optoelectronic unit includes two electrodes, an optoelectronic chip, a horizontal surface and an active surface, wherein the two electrodes extend from the horizontal surface to the active surface, the optoelectronic chip is attached to the active surface and coupled to the two electrodes to output or receive the optical signals, the optoelectronic unit is disposed at the other side of the positioning groove, the optoelectronic chip is aligned with the support groove and the two electrodes are coupled to the control chip respectively via a conductive line. One end of the optical waveguide is placed inside the support groove. The mount includes at least one through hole, wherein the other end of the optical waveguide penetrates through the at least one through hole.

In the optical engine assembly and optoelectronic package of the present disclosure, the optoelectronic chip may be a laser chip or a photodetector; and the optical waveguide may be an optical fiber surrounded by a ferrule and a holder.

In the optical engine assembly and optoelectronic package of the present disclosure, the horizontal surface may be an upper surface or a bottom surface of the optoelectronic unit and the horizontal surface is parallel to the upper surface of the bench. Parts of the two electrodes at the horizontal surface are respectively connected to the conductive lines.

In the optical engine assembly and optoelectronic package of the present disclosure, a cross section of the positioning groove may have a “ [symbol] ” shape, and the horizontal surface may be substantially perpendicular to the active surface.

In the optical engine assembly and optoelectronic package of the present disclosure, a front end of the optical waveguide is substantially perpendicularly to the upper surface of the bench.

In the optical engine assembly and optoelectronic package of the present disclosure, as the optical signals generated by the optoelectronic unit are parallel to the substrate, it is able to directly align the optoelectronic chip with the optical fiber. In addition, as the cross section of the positioning groove has a “ [symbol] ” shape, the optical fiber may be placed very close to the optoelectronic chip thereby significantly increasing the coupling efficiency.

### BRIEF DESCRIPTION OF THE DRAWINGS

Other objects, advantages, and novel features of the present disclosure will become more apparent from the following detailed description when taken in conjunction with the accompanying drawings.

FIG. 1 shows a schematic diagram of a conventional optical engine assembly.

FIG. 2 shows a bottom view of the light redirecting element of the optical engine assembly of FIG. 1.

FIG. 3 shows a cross-sectional view taken along line of the optical engine assembly of FIG. 1.

FIG. 4 shows an exploded diagram of the optoelectronic package according to an embodiment of the present disclosure.

FIG. 5 shows a schematic diagram of the optoelectronic package according to the embodiment of the present disclosure.

FIG. 6 shows a flow chart of fabricating the optoelectronic package according to the embodiment of the present disclosure.

FIGS. 7A-7H show schematic diagrams of fabricating the optoelectronic package according to the embodiment of the present disclosure.

FIGS. 8A-8B show enlarged side views of a part of the optoelectronic package according to the embodiment of the present disclosure.

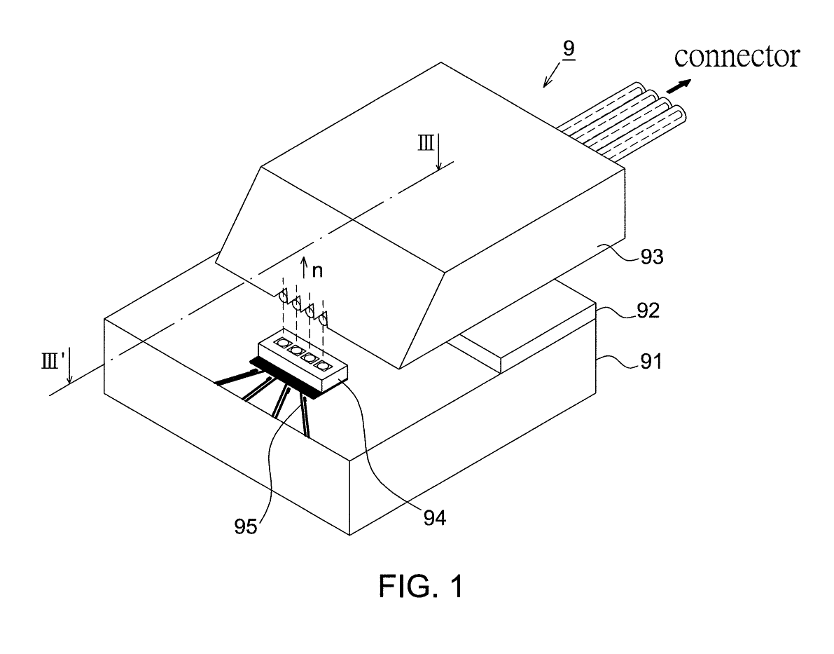

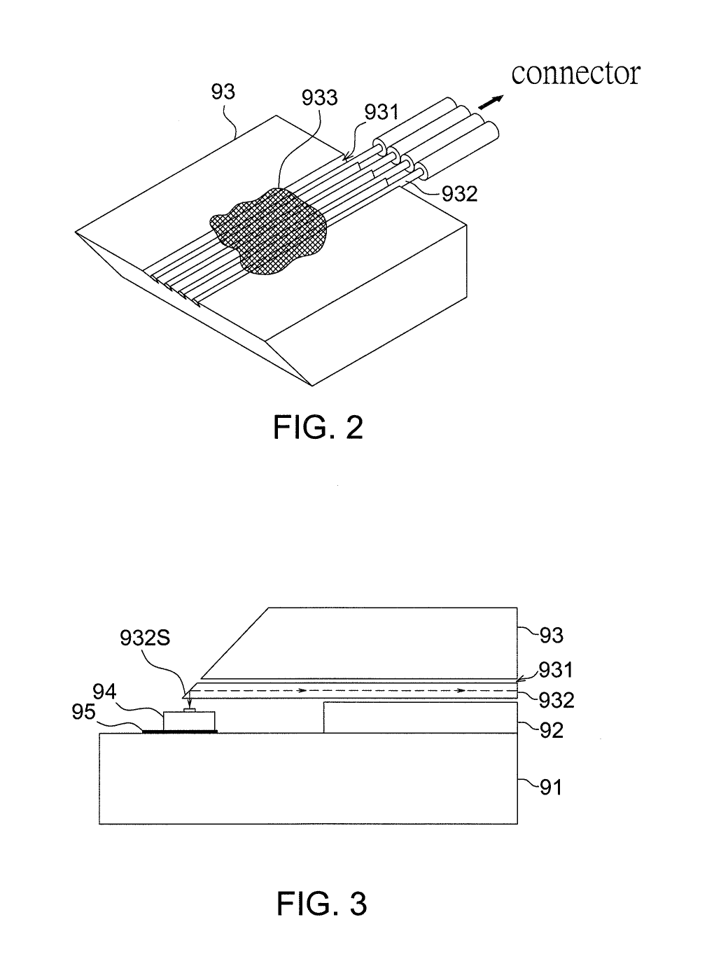

### DETAILED DESCRIPTION OF THE EMBODIMENT

It should be noted that, wherever possible, the same reference numbers will be used throughout the drawings to refer to the same or like parts.

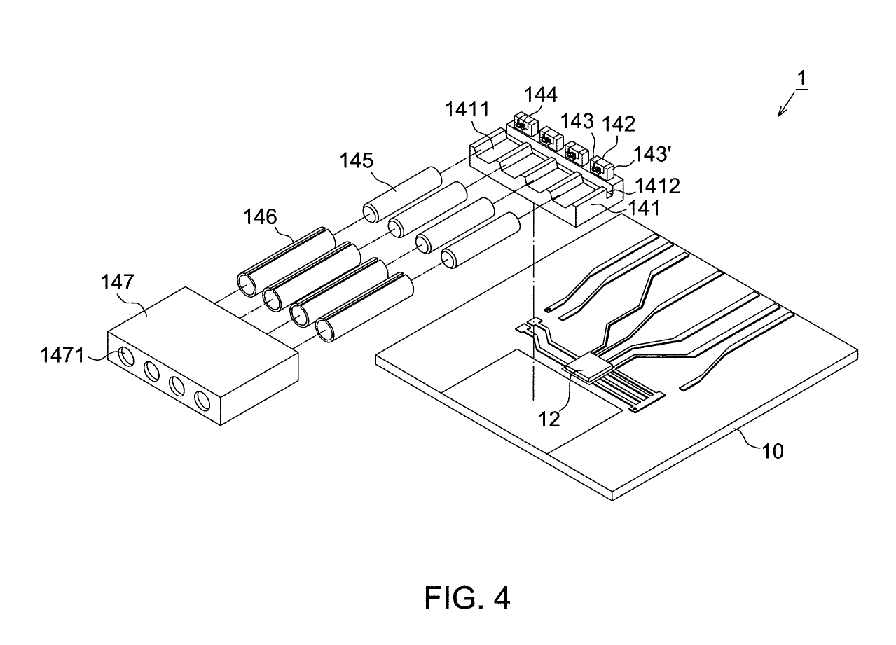

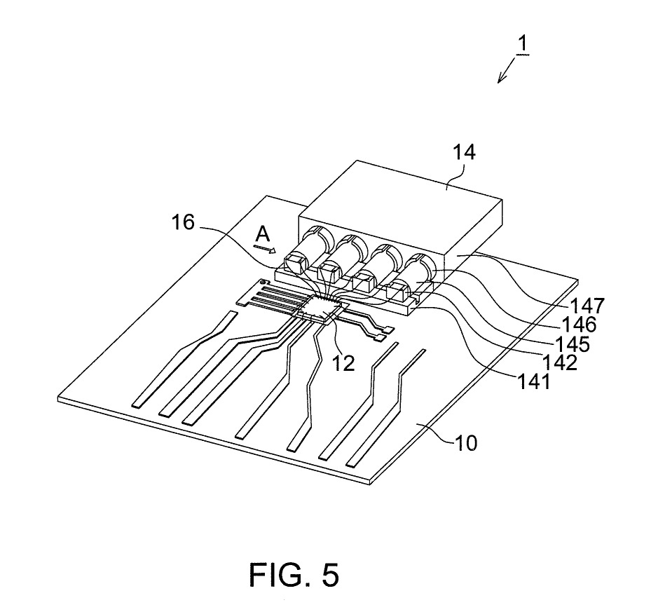

Please refer to FIGS. 4 and 5, FIG. 4 shows an exploded diagram of the optoelectronic package according to an embodiment of the present disclosure and FIG. 5 shows a schematic diagram of the optoelectronic package according to the embodiment of the present disclosure. The optoelectronic package 1 of the present disclosure includes a substrate 10, a control chip 12 and an optical engine assembly 14.

The substrate 10 is preferably a PCB substrate and configured to provide the power needed by the control chip 12 and the optical engine assembly 14 during operation. A plurality of conductive lines and through vias are formed on the substrate 10 configured to transmit electric signals, wherein the method of forming conductive lines and through vias on a PCB substrate is well known and thus details thereof will not be repeated herein. In addition, it is appreciated that the circuit layout on the substrate 10 is different corresponding to different operations and functions of the optical engine assembly 14. For example, the substrate 10 has different circuit layouts corresponding to the signal generating and the signal receiving of the optical engine assembly 14.

The control chip 12 is attached to an upper surface of the substrate 10 and configured to output electric signals to the optical engine assembly 14 or to receive electric signals detected by the optical engine assembly 14.

The optical engine assembly 14 includes a bench 141, at least one optoelectronic unit 142, at least one optical waveguide 145, at least one holder 146 and a mount 147, wherein each optoelectronic unit 142 further includes two electrodes 143 and 143′, an optoelectronic chip 144, a horizontal surface 142H and an active surface 142V.

The bench 141 is preferably a silicon substrate and at least one support groove 1411 and a positioning groove 1412 are formed, e.g. by etching on its upper surface. The support groove 1411 is configured to support the optical waveguide 145, and a size and a number of the support groove 1411 are determined according to the optical waveguide 145 to be supported; for example, the number thereof may be determined by a channel number that the optical engine assembly 14 transmits. The positioning groove 1412 is configured to allow the front end tip of the optical waveguide 145 to be as close to the optoelectronic chip 144 as possible so as to improve the coupling efficiency therebetween, and the positioning groove 1412 may be formed by photolithography and etching and then cut by the diamond tool (described later). In this embodiment, the support groove 1411 is connected to the positioning groove 1412 and substantially perpendicularly extends outward from one side, e.g. the side away from the control chip 12 herein, of the positioning groove 1412. In addition, as the surface of the silicon substrate is smoother than that of the PCB substrate, a merit of using the bench 141 is to accurately align the components disposed thereon so as to increase the coupling efficiency.

The optoelectronic unit 142 is attached to the upper surface of the bench 141 and located at the other side, e.g. the side close to the control chip 12 herein of the positioning groove 1412. The optoelectronic unit 142 has a horizontal surface 142H and an active surface 142V, wherein the horizontal surface 142H may be an upper surface or a bottom surface of the optoelectronic unit 142 and is substantially parallel to the upper surface of the bench 141. The active surface 142V faces the support groove 1411. A number of the optoelectronic unit 142 is preferably equal to a number of the support groove 1411. The optoelectronic unit 142 may be a hexahedron, e.g. a cube or a rectangular parallelepiped, but not limited thereto. The optoelectronic unit 142 may have any shape as long as it includes a horizontal surface 142H parallel to the upper surface of the bench 141 and an active surface 142V facing the support groove 1411. The horizontal surface 142H is substantially perpendicular to the active surface 142V.

The two electrodes 143 and 143′ are formed on the optoelectronic unit 142, extend from the horizontal surface 142H to the active surface 142V and are electrically coupled to the optoelectronic chip 144. The two electrodes 143 and 143′ are coupled to the control chip 12 on the substrate 10 respectively through a conductive line 16 such as, but not limited to, a gold line, wherein the conductive lines 16 may be formed by gold traces on the substrate 10 or wire bonding to connect between the control chip 12 and the parts of the two electrodes 143 and 143′ at the horizontal surface 142H. Since an included angle between the horizontal surface 142H and the active surface 142V is substantially equal to 90 degrees, the two electrodes 143 and 143′ respectively have two parts having 90 degrees included angle, wherein the parts at the horizontal surface 142H are easy to be coupled to the control chip 12 on the substrate 10 and the parts at the active surface 142V are easy to be electrically coupled to the optoelectronic chip 144.

The optoelectronic chip 144 may be, for example, a laser chip or a photodetector that may be attached to the active surface 142H of the optoelectronic unit 142 and electrically coupled to the two electrodes 143 and 143′. In other words, the optoelectronic chip 144 is opposite to the support groove 1441 so as to generate or receive optical signals parallel to the upper surface of the bench 141.

The optical waveguide 145 may be, for example, an optical fiber surrounded by a ferrule and is placed inside the support groove 1411 of the bench 141 and aligned with the optoelectronic chip 144. In addition to the front portion of the optical waveguide 145 placed inside the support groove 1411, other portions of the optical waveguide 145 may further be surrounded by a holder 146 for being coupled to the outside of the optical engine assembly 14. In other words, in the present embodiment said optical waveguide 145 may refer to the optical fiber surrounded by both the ferrule and the holder 146, or refer to the optical fiber surrounded by the ferrule only. It is appreciated that the alignment between the optical waveguide 145 and the optoelectronic chip 144 refers to the alignment between the output/input hole of optical signals in front of the optical waveguide 145 and the active surface of a laser chip or a photodetector. It is appreciated that, in other embodiments a center of the optoelectronic unit 142 may not be opposite to the support groove 1411 as long as the optoelectronic chip 144 is aligned with the optical waveguide 145. In addition, it is possible to form a plurality of optoelectronic chips on a single optoelectronic unit having a relatively larger size, i.e. one optoelectronic unit may not be associated with only one channel.

The mount 147 is configured to fix the optical waveguide 145 and has at least one through hole 1471 to allow the optical waveguide 145 to penetrate therethrough, wherein the optical waveguide 145 protrudes from the through hole 1471 of the mount 147 is configured to be coupled to an external optical connector. It is appreciated that a diameter of the though hole 1471 of the mount 147 is preferably just fit an outside diameter of the optical waveguide 145 (or the holder 146) so as to tightly hold the optical waveguide 145.

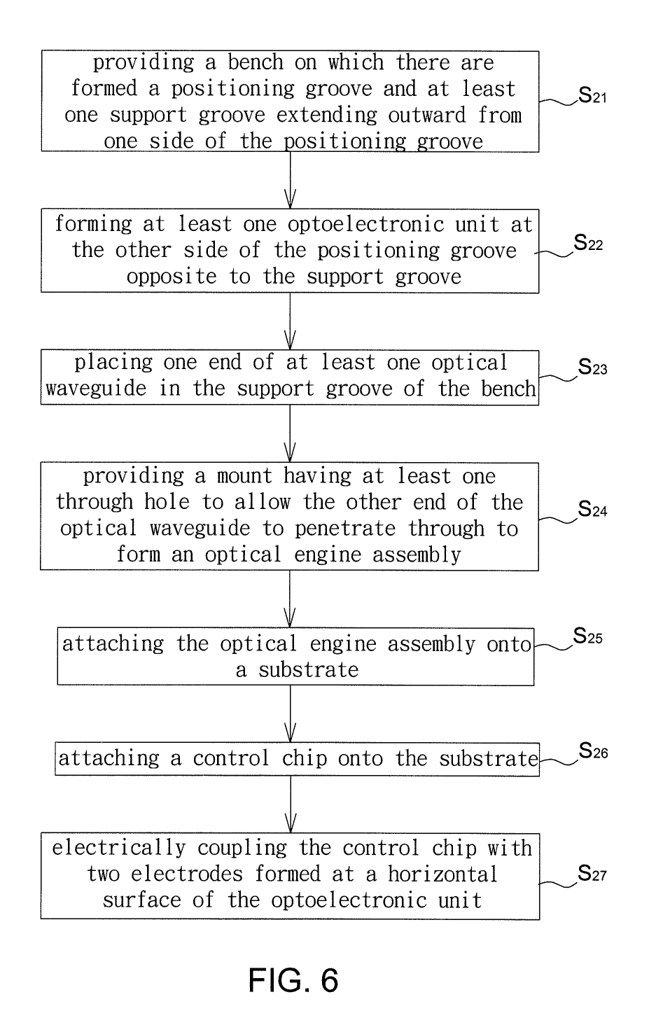

Please refer to FIG. 6, it shows a flow chart of fabricating the optoelectronic package 1 according to an embodiment of the present disclosure, which includes the steps of: providing a bench on which there are formed a positioning groove and at least one support groove perpendicularly extending outward from one side of the positioning groove (Step S₂₁); forming at least one optoelectronic unit at the other side of the positioning groove on the bench opposite to the support groove (Step S₂₂); placing one end of at least one optical waveguide in the support groove of the bench (Step S₂₃); providing a mount having at least one through hole to allow the other end of the optical waveguide to penetrate through to form an optical engine assembly (Step S₂₄); attaching the optical engine assembly onto a substrate (Step S₂₅); attaching a control chip onto the substrate (Step S₂₆); and electrically coupling the control chip with two electrodes formed at a horizontal surface of the optoelectronic unit of the optical engine assembly (Step S₂₇).

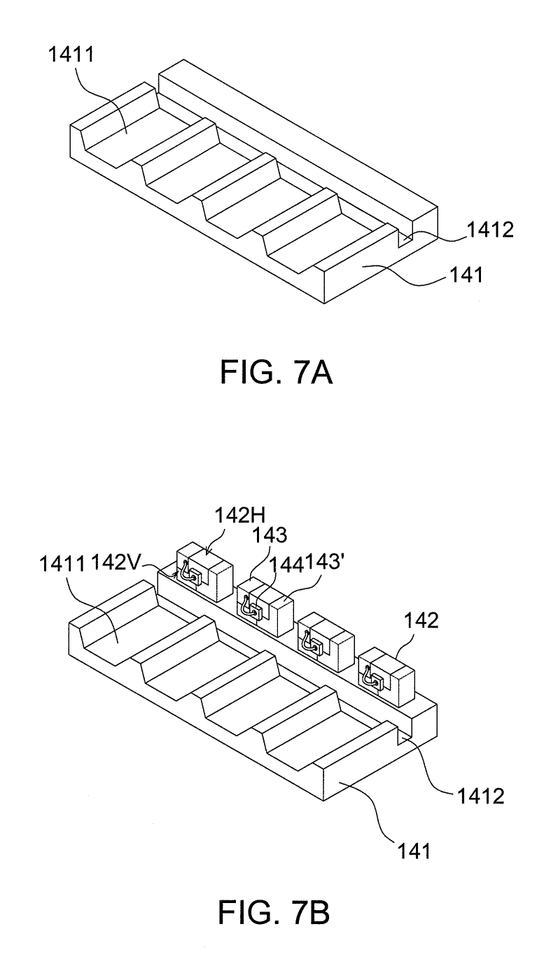

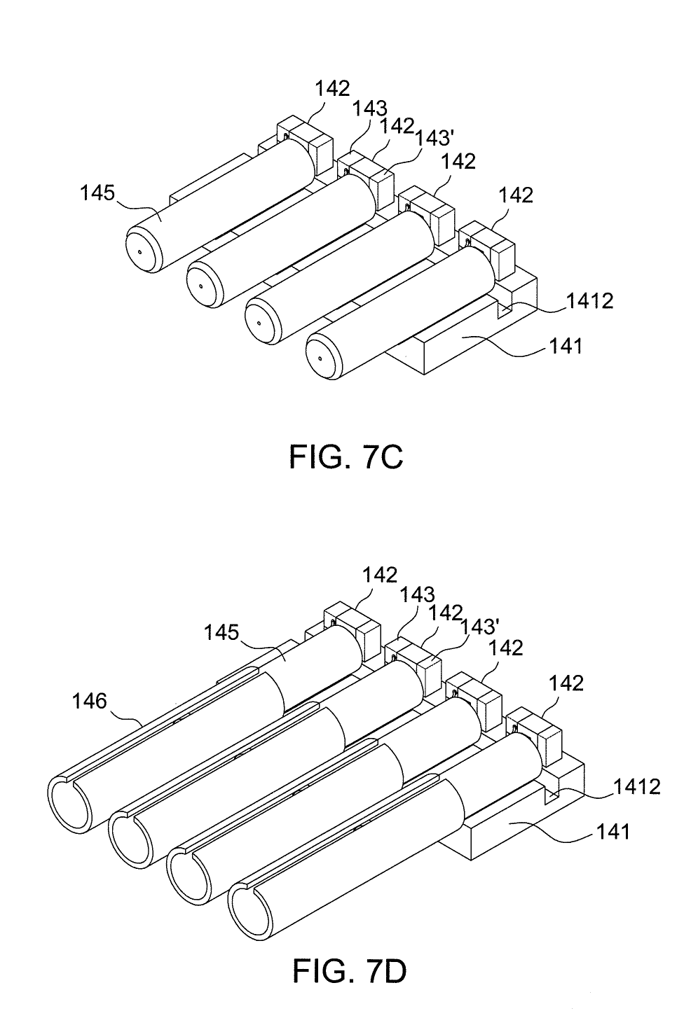

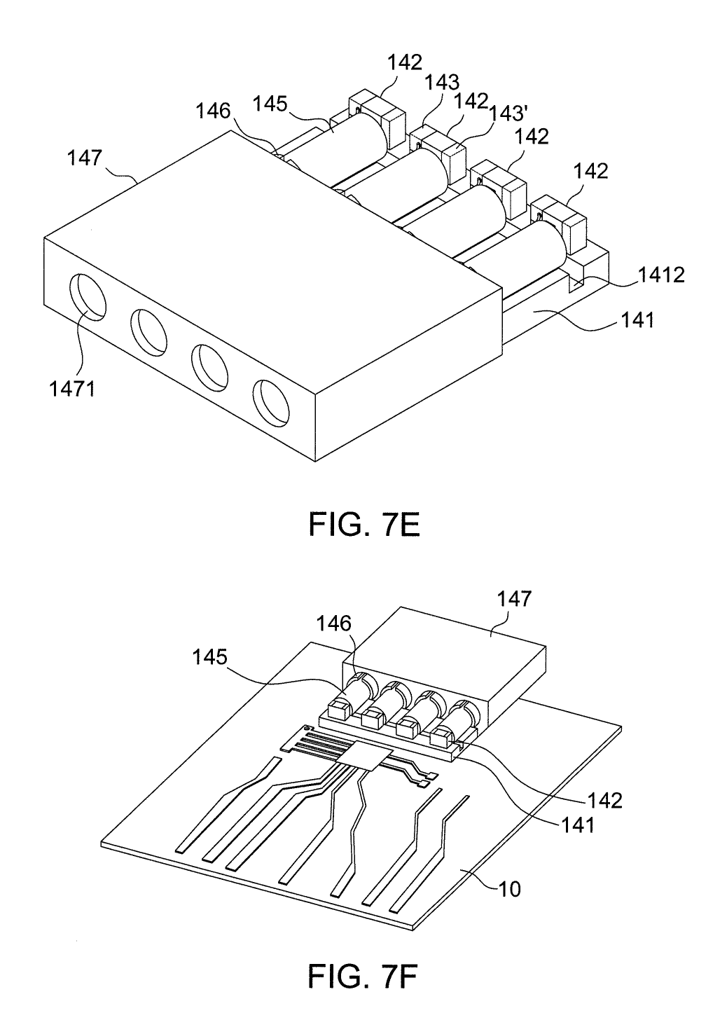

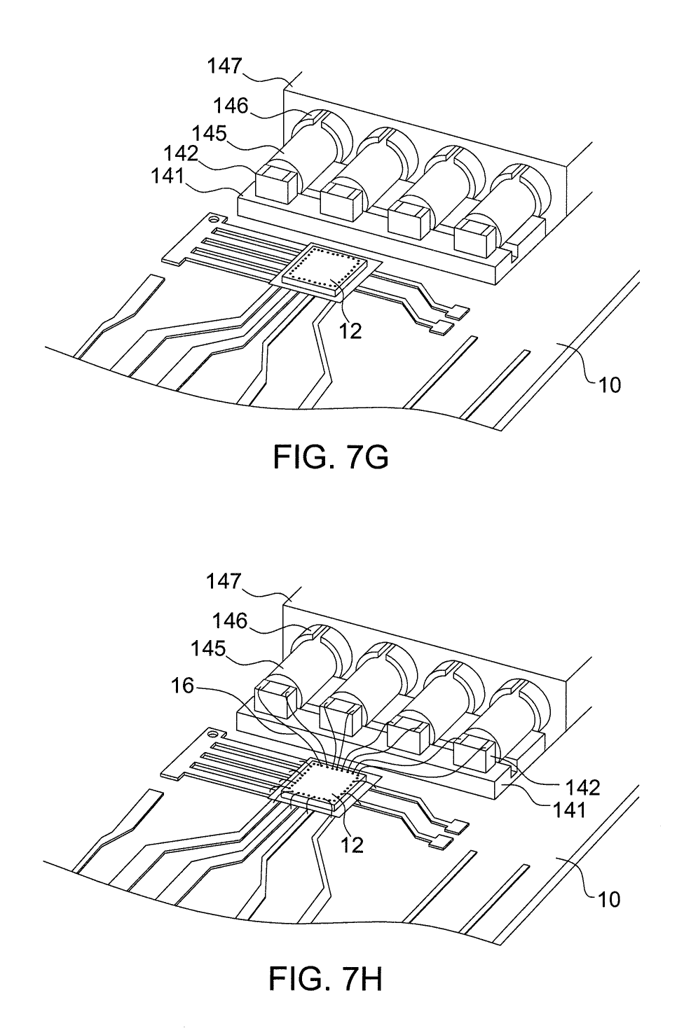

Please refer to FIGS. 6 and 7A-7H together, the fabricating method of the optoelectronic package 1 according to the embodiment of the present disclosure will be illustrated hereinafter. First, a substrate (e.g. a silicon substrate) is provided to be served as a bench 141, and the support groove 1411 and the positioning groove 1412 are formed, e.g. by etching on the bench 141 as shown in FIG. 7A (Step S₂₁), wherein the support groove 1411 substantially perpendicularly extends outward from one side of the positioning groove 1412.

Next, attaching at least one optoelectronic unit 142 (e.g. four are shown herein) at the other side of the positioning groove 1412 onto the upper surface of the bench 141, wherein two electrodes 143 and 143′ extending from a horizontal surface 142H to an active surface 142V of the optoelectronic unit 142 are previously formed, and an optoelectronic chip 144 is previously formed on the active surface 142V. In this step the optoelectronic chip 144 is aligned with the support groove 1411 as shown in FIG. 7B (Step S₂₂). In other words, the optoelectronic chip 144 may not be located at a center of the active surface 142V of the optoelectronic unit 412, and the optoelectronic chip 144 may be located at any suitable position at the active surface 142V as long as the optoelectronic chip 144 is aligned with the support groove 1411.

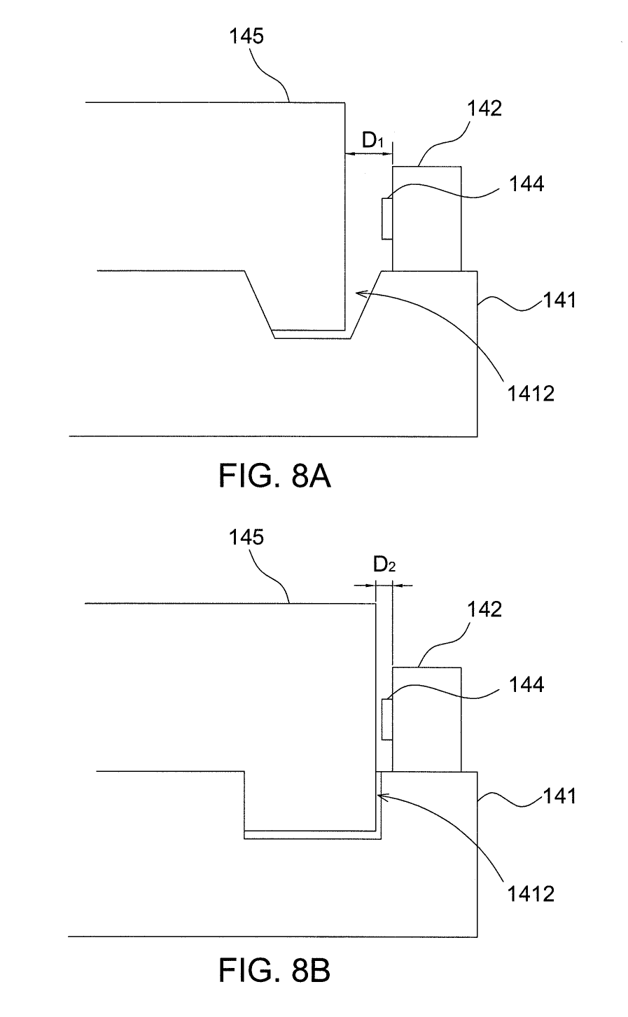

Next, one end of at least one optical waveguide 145 is placed in the support groove 1411 of the bench 141 as shown in FIG. 7C. Please refer to FIGS. 8A and 8B, the cross section of a groove formed by etching will be like FIG. 8A which has beveled sidewalls such that a larger distance D₁ is left when aligning the optical waveguide 145 with the optoelectronic chip 144. Therefore, in this embodiment the positioning groove 1412 is first formed by etching to have said beveled sidewalls and then a diamond blade is further used to cut the beveled sidewalls to become substantial vertical sidewalls (e.g. a “U” shape) as shown in FIG. 8B. In this manner, it is able to shorten the distance, e.g. D₂, between the optical waveguide 145 and the optoelectronic chip 144 during alignment so as to improve the coupling efficiency. Next, the holder 146 is used to hold the other portions of the optical waveguide 145 that is not placed inside the support groove 1411, and preferably a part of the front end tip of the holder 146 is in collision with the bench 141 to better fix the optical waveguide 145 as shown in FIG. 7D (Step S₂₃). It is appreciated that in other embodiments, the holder 146 may be previously put on the optical waveguide 145 and then the optical waveguide 145 surrounded by the holder 146 is placed inside the support groove 1411. In other words, the optical waveguide 145 referred in the present embodiment may include the holder 146.

Next, a mount 147 having at least one through hole 1471 (e.g. four through holes are shown herein) is provided, and the other side of the optical waveguide 145 penetrates through the through hole to be fixed as shown FIG. 7E, wherein the structure shown in FIG. 7E is the optical engine assembly referred in the present disclosure (Step S₂₄).

Next, the optical engine assembly 14 is combined with a substrate 10 as shown in FIG. 7F, wherein the optical engine assembly 14 may be combined with the substrate 10 using an adhesive, a retaining member or other fixing members without particular limitation as long as the optical engine assembly 14 can be attached to the substrate 10 safely (Step S₂₅).

Next, a control chip 12 is attached onto the substrate 10 as shown in FIG. 7G, wherein the method of attaching a chip onto a substrate is well known and described in literatures and details thereof will not be repeated herein (Step S₂₆).

Finally, the control chip 12 is electrically coupled to the parts of the two electrodes 143 and 143′ formed at the horizontal surface 142H of the optoelectronic unit 142 through wire bonding or gold traces formed on the substrate 10 as shown in FIG. 7H, wherein although the horizontal surface 142H shown in FIG. 7H is the upper surface of the optoelectronic unit 142, it is not used to limit the present disclosure. For example, the horizontal surface 142H may also be the bottom surface of the optoelectronic unit 142 (Step S₂₇).

In the present disclosure, by forming two electrodes 143 and 143′ extending from the horizontal surface 142H to the active surface 142V of the optoelectronic unit 142, it is convenient to electrically connect the optoelectronic unit 142 to the control chip 12 and directly generate optical signals parallel to the bench 141. Therefore, the front end of the optical waveguide 145 needs not to be polished to form a 45-degree beveled angle and can be disposed vertically with respect to the upper surface of the bench 141. In this embodiment, the upper surface of the bench 10 is parallel to the surface of the substrate 10.

As mentioned above, in conventional optical engine assemblies it is necessary to output and receive optical signals through a light redirecting element and a 45-degree beveled surface has to be formed on the optical fiber to be served as a reflecting mirror, and thus the fabricating process is complicated. The present disclosure further provides an optical engine assembly and an optoelectronic package (FIGS. 4 and 5) that directly generates optical signals parallel to the substrate and has a lower manufacturing complexity and a higher coupling efficiency.

Although the disclosure has been explained in relation to its preferred embodiment, it is not used to limit the disclosure. It is to be understood that many other possible modifications and variations can be made by those skilled in the art without departing from the spirit and scope of the disclosure as hereinafter claimed.

What is claimed is:

1. An optical engine assembly, comprising:
a bench, wherein at least one support groove and a positioning groove are formed on an upper surface of the bench and connected with each other, and the support groove perpendicularly extends outward from one side of the support groove;
at least one optoelectronic unit comprising two electrodes, an optoelectronic chip, a horizontal surface and an active surface, wherein the two electrodes extend from the horizontal surface to the active surface, the optoelectronic chip is attached to the active surface and coupled to the two electrodes, the optoelectronic unit is disposed at the other side of the positioning groove and the optoelectronic chip is aligned with the support groove;
at least one optical waveguide, wherein one end of the optical waveguide is placed inside the support groove; and
a mount comprising at least one through hole, wherein the other end of the optical waveguide penetrates through the at least one through hole.

2. The optical engine assembly as claimed in claim 1, wherein the optoelectronic chip is a laser chip or a photodetector.

3. The optical engine assembly as claimed in claim 1, wherein the optical waveguide is an optical fiber surrounded by a ferrule and a holder.

4. The optical engine assembly as claimed in claim 1, wherein the horizontal surface is an upper surface or a bottom surface of the optoelectronic unit and is parallel to the upper surface of the bench.

5. The optical engine assembly as claimed in claim 1, wherein a cross section of the positioning groove has a “ [symbol] ” shape.

6. The optical engine assembly as claimed in claim 1, wherein the horizontal surface is perpendicular to the active surface.

7. The optical engine assembly as claimed in claim 1, wherein a front end of the optical waveguide is perpendicular to the upper surface of the bench.

8. An optoelectronic package, comprising:
a substrate;
a control chip attached to the substrate; and
an optical engine assembly attached to the substrate and coupled to the control chip to output or receive optical signals, the optical engine assembly further comprising:
a bench, wherein at least one support groove and a positioning groove are formed on an upper surface of the bench and connected with each other, and the support groove perpendicularly extends outward from one side of the support groove;
at least one optoelectronic unit comprising two electrodes, an optoelectronic chip, a horizontal surface and an active surface, wherein the two electrodes extend from the horizontal surface to the active surface, the optoelectronic chip is attached to the active surface and coupled to the two electrodes to output or receive the optical signals, the optoelectronic unit is disposed at the other side of the positioning groove, the optoelectronic chip is aligned with the support groove and the two electrodes are coupled to the control chip respectively via a conductive line;
at least one optical waveguide, wherein one end of the optical waveguide is placed inside the support groove; and
a mount comprising at least one through hole, wherein the other end of the optical waveguide penetrates through the at least one through hole.

9. The optoelectronic package as claimed in claim 8, wherein the optoelectronic chip is a laser chip or a photodetector.

10. The optoelectronic package as claimed in claim 8, wherein the optical waveguide is an optical fiber surrounded by a ferrule and a holder.

11. The optoelectronic package as claimed in claim 8, wherein the horizontal surface is an upper surface or a bottom surface of the optoelectronic unit and is parallel to the upper surface of the bench; and parts of the two electrodes at the horizontal surface are respectively connected to the conductive lines.

12. The optoelectronic package as claimed in claim 8, wherein a cross section of the positioning groove has a “ [symbol] ” shape.

13. The optoelectronic package as claimed in claim 8, wherein the horizontal surface is perpendicular to the active surface.

14. The optoelectronic package as claimed in claim 8, wherein a front end of the optical waveguide is perpendicular to the upper surface of the bench.
